(19) United States
(12) Patent Application Publication
(10) Pub. No.: US 2009/0167122 A1
(43) Pub. Date: Jul. 2, 2009

(54) RECTIFIER AND ELECTRIC MACHINE COMPRISING SAID TYPE OF DEVICE

(76) Inventors: Dieter Schurig, Wallrabenstein (DE); Ramesh Rangarao, Bangalore (IN); Guillermo Ballesteros, Toluca (MX)

Correspondence Address: MICHAEL J. STRIKER, 103 EAST NECK ROAD, HUNTINGTON, NY, 11743, US

(21) Appl. No.: 11/571,065

(22) PCT Filed: Aug. 17, 2005
(86) PCT No.: PCT/EP2005/054061

§ 371 Date: Dec. 21, 2006

(30) Foreign Application Priority Data
Aug. 21, 2004 (DE) 10 2004 040 595.6

(51) Int. Cl. H02K 11/04

(52) U.S. Cl. 310/68 D

(57) ABSTRACT

The invention relates to a rectifier unit comprising one plus cooling body (27) which supports at least one plus-diode (32), and one minus cooling body (28) which supports at least one minus diode (31). A spacer (29), which is made of an insulating material (70), electrically separates the plus cooling body (27) and the minus cooling body (28). A wiring plate (30) comprises at least one conductor element which enables the at least one plus-diode (32) and the at least one minus-diode (31) to be wired in a bridge rectifier circuit. Said conductor element is a flat webbed cable (33). According to the invention, the flat webbed cable (33) supports a bolt-like connection (48).

### RELATED ART

The present invention relates to a rectifier and an electric machine with an inventive rectifier according to the general class of the independent claim. Of the known rectifier units, e.g., as made known in European patent EP 0 960 464 B1, no special connectors are known, which are guided away from the wiring plate in an axially outward direction, for example. The disadvantage of these embodiments is that certain voltage signals from the wiring plate can therefore not be sampled directly from the outside.

### ADVANTAGES OF THE INVENTION

The inventive rectifier unit with the features of the main claim has the advantage that, by providing a bolt-type connector on one of the flat webbed cables of the rectifier unit, a connector is provided from which electrical signals can be tapped.

Advantageous refinements of the rectifier unit are made possible by the measures described in the subclaims.

Given that the flat webbed cable has a U-shaped bolt receptacle on which the bolt-type connector is mounted, it is possible to provide a suitable holding device for the bolt-type connector in a favorable manner, e.g., using simple wires.

Given that the bolt-type connector has a receiving neck, which is placed in U-shaped bolt receptacle 1, good positioning results and, therefore, so does good quality of the connector between the receiving neck and the bolt receptacle. Using a type of fit, it is hereby made possible to accommodate the receiving neck in a form-fit manner. A further advantageous design is given when the bolt-type connector has a bolt section which is located after the receiving neck and on which the U-shaped bolt receptacle is mounted. This design results in a type of step in which the flat webbed cable fits and is accommodated. In addition, the contact surface between the flat webbed cable and the bolt-type connector is at least doubled in size, and contact resistance is therefore particularly low. In addition, the connection point can be designed to be particularly strong, since the contact surfaces are relatively large.

If the outer circumference of the bolt section located after the receiving neck is designed such that a type of form-fit contour is provided there, a particularly favorable transfer or introduction of force can take place when the conductor element and bolt-type connector are extrusion-coated accordingly. For example, screw forces acting on the bolt-type connector would not be directed only via the bolt receptacle into the wiring plate. Instead, they would be largely directed via the form-fit connector into the jacket made of insulating material, thereby resulting in particularly good force deflection.

When a collar-type section is located at least immediately after the receiving neck, the diameter of which is greater than that of the receiving neck and/or the bolt section located after the receiving neck, this results in a large contact area on the bolt-type connector for perforated contact tabs, for example.

To reliably fasten a contact tab, it is provided that a screw thread bolt section be provided on the bolt-type connector.

Reliable connecting methods between the flat webbed cable and the bolt-type connector are, e.g., welding or soldering.

According to a further embodiment, it is provided that the electric machine with the inventive rectifier unit includes a protective cap which covers the rectifier unit and extends through the bolt-type connector through an opening in the protective cap. This makes it possible to fasten a tab to this bolt-type connector from outside of the electric machine.

### DRAWING

Exemplary embodiments of the inventive rectifier unit are shown in the drawing.

FIG. 1 shows a spacial view of the inventive rectifier unit,

FIG. 2 shows a top view of the inventive rectifier unit,

FIGS. 3a and 3b show two views of a flat webbed cable,

FIGS. 4a through 4d show various designs of a connector,

FIG. 5 shows a connector with flat webbed cables located one on top of the other,

FIG. 6 is a schematic view of a protective cap and the connector passing through it,

FIG. 7 is a schematic view of an electric machine,

FIG. 8 is an alternative embodiment of the rectifier unit.

### DESCRIPTION

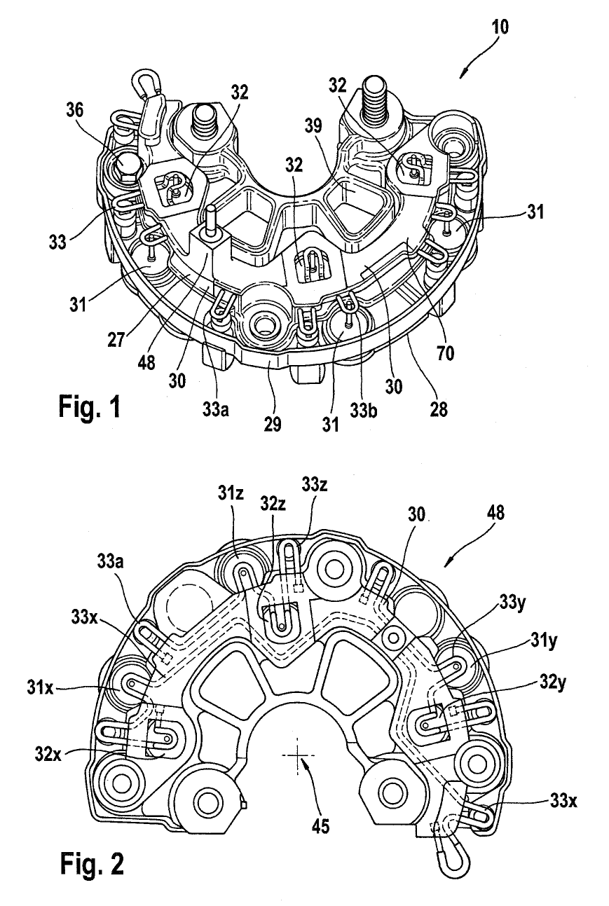

Details of a rectifier unit 10 are shown in FIGS. 1 and 2. Rectifier unit 10 is composed of a plate-shaped, positive heat sink 27 and a negative heat sink 28 made of a thermally conductive metal, preferably aluminum. The two stacked heat sinks 27 and 28 are electrically insulated from each other by a spacer 29, and they are both fastened with a wiring plate 30 located on upper heat sink 27 in a layered manner on an end region of a bearing plate of an electric machine, which forms a not-shown, rear shell half. Several negative diodes 31 are pressed with their anode connection into negative heat sink 27 in preferably ribbed bores. Negative heat sink 28 should be fastened flat on the end face of rear shell half, to direct dissipation heat away from negative diodes 31. Several positive diodes 32 are pressed with their cathode sides into positive heat sink 27 in the same manner. A series circuit of a negative diode 31 with a positive diode 32 and its wiring with one end of a stator winding is accomplished using a flat webbed cable 33 which is embedded in an insulating material 70, e.g., plastic, in a wiring plate 30, except for its terminal ends 33a and 33b. Wiring plate 30, positive heat sink 27, spacer 29 and negative heat sink 28 are screwed into position on top of each other on the end face of rear shell half using fastening screws 36.

FIG. 2 shows rectifier unit 10, in a front view. The three flat webbed cables 33x, 33y, and 33z embedded in wiring plate 30 are shown clearly. Axis direction 45 indicated in FIG. 2 corresponds to the axis of rotation of the electric machine, i.e., its rotor.

As shown in FIG. 2, a bridge rectifier circuit is formed between a negative diode 31x and a positive diode 32x, e.g., via flat webbed cable 33x. In a similar manner, a bridge rectifier circuit is formed between negative diode 31z and positive diode 32z by flat webbed cable 33z. In addition, a bridge rectifier circuit is formed between negative diode 31y and positive diode 32y by flat webbed cable 33y. All three flat webbed cables are separated from each other electrically in this wiring plate 30, of course. As shown in FIG. 2, it is provided that bolt-type connector 48 is mounted on flat webbed cable 33y.

A rectifier unit 10 is therefore provided which has a positive heat sink 27, on which at least one positive diode 32x, 32y, 32z is mounted, and a negative heat sink 28, on which at least one negative diode 31x, 31y, 31z is mounted. A spacer 29 made of an insulating material 70 is provided which electrically separates positive heat sink 27 from negative heat sink 28. Rectifier unit 10 also includes a wiring plate 30 which includes at least one conductor element, via which the at least one positive diode 32x, 32y, 32z is connected with the at least one negative diode 31x, 31y, 31z in a bridge rectifier circuit. Conductor element is a flat webbed cable 33, which has electrically conductive contact with bolt-type connector 48, which is mounted on it.

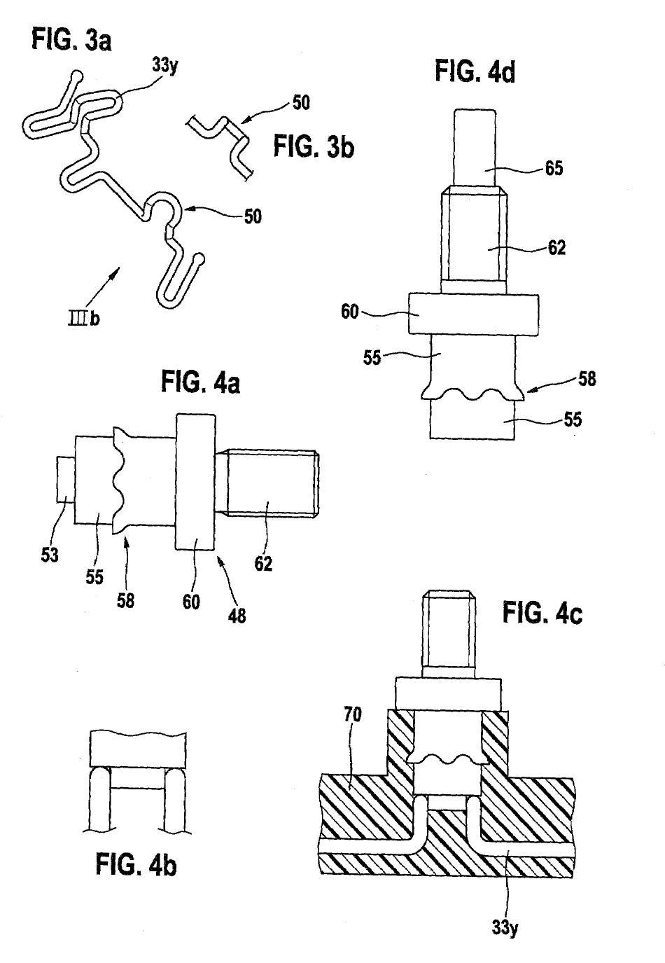

FIG. 3a shows flat webbed cable 33y in sections, in a top view. A U-shaped bolt receptacle 50 is shown clearly. FIG. 3b shows flat webbed cable 33y in sections, in a side view. Bolt-type connector 48 is accommodated on this U-type bolt receptacle in a manner described below.

Bolt-type connector 48 can have various designs overall. As shown in FIG. 4a, it can include, e.g., a receiving neck 53 which is inserted in U-shaped bolt receptacle 50, FIG. 4b. A bolt section 55 is preferably located after receiving neck 53, with which bolt-type connector 48 is mounted on U-shaped bolt receptacle 50.

Bolt section 55, which is located after receiving neck 53, has a form-fit contour 58 on its outer circumference. Form-fit contour 58 and the at least one conductor element of wiring plate 30 are enclosed by an insulating material 70, and insulating material 70 encloses form-fit contour 58, FIG. 4c.

It is provided that a collar 60 is located at least directly after receiving neck 53, the outer diameter of which is greater than that of receiving neck 53 and/or of bolt section 55 located after receiving neck 53. In this case, “at least directly after” means that bolt section 55, for example, is located between collar 60 and receiving neck 53. It can also mean that there need not be a section, e.g., bolt section 55, between receiving neck 53 and collar 60, i.e., collar 60 is located directly after receiving neck 53. As shown in FIG. 4a, it is provided that a screw thread 62 is part of bolt-type connector 48 in the direction toward an end of bolt-type connector 48 opposite to U-shaped bolt receptacle 50.

A variant of bolt-type connector 48 is shown in FIG. 4d. It includes bolt section 55, with which it is fastened on flat webbed cable 33y. Collar 60 is located after bolt section 55. Screw thread 62 is located after collar 60, and this is followed by a cylindrical peg 65 with an outer diameter which is smaller than that of screw thread 62. Cylindrical peg 65 is provided to accommodate parts which can be inserted in place. As an alternative, peg 65 can also be provided as shown in the exemplary embodiment depicted in FIG. 4a.

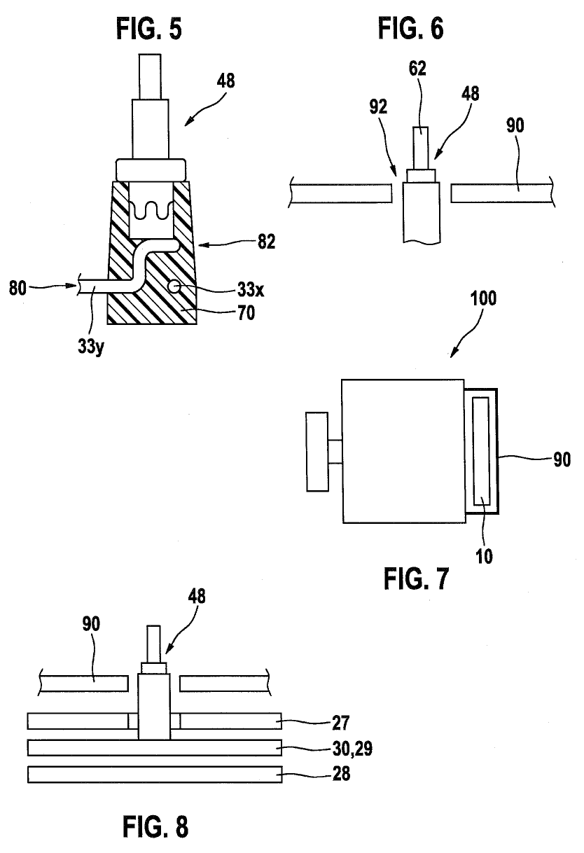

FIG. 5 shows an assembly example in which bolt-type connector 48 is connected with a flat webbed cable 33y according to the exemplary embodiment depicted in FIG. 4d. As shown here, flat webbed cable 33y is essentially U-shaped, as mentioned above, and this U shape starts in a first plane 80 and extends into a second plane. As shown in FIG. 5, flat webbed cable 33y therefore extends in two different planes which are based on an axis of the generator or the rotor. Flat webbed cable 33y is located near its receptacle 85 over another flat webbed cable, which is flat webbed cable 33x in this example. Flat webbed cables 33x and 33y from two different bridge rectifier circuits are therefore located in two different planes 80 and 82. Flat webbed cable 33y is bonded with bolt-type connector 48; welding or soldering are preferred. As shown in FIG. 6, it is provided that a protective cap 90 covers the rectifier unit. Bolt-type connector 48 extends through an opening 92 of protective cap 90.

FIG. 7 shows, in a highly schematized manner, an electric machine 100 on which an inventive rectifier unit 10 is mounted. Rectifier unit 10 is covered with a protective cap 90. Rectifier unit 10 does not necessarily have to be designed such that spacer 29 and wiring plate 30 are spacially separated. Wiring plate 30 can also serve as a spacer 29; it would then be located between negative heat sink 28 and positive heat sink 27. In this case, wiring plate 30 also includes a bolt-type connector 48 which extends initially through positive heat sink 27, so that it ultimately—as shown in FIG. 6—also extends through a protective cap 90. See also FIG. 8. As an alternative to the exemplary embodiments described above, it is also possible for the negative heat sink to be realized by a bearing plate of the electric machine. In this case, the further parts of rectifier unit 10 would be placed on the bearing plate.

What is claimed is:

1. A rectifier unit with a positive heat sink (27) on which at least one positive diode (32) is mounted, and a negative heat sink (28) on which at least one negative diode (31) is mounted, with a spacer (29) made of an insulating material (70) which electrically separates the positive heat sink (27) from the negative heat sink (28), with a wiring plate (30) with at least one conductor element which enables the at least one positive diode (32) and the at least one negative diode (31) to be wired in a bridge rectifier circuit; the conductor element is a flat webbed cable (33),
wherein
the flat webbed cable (33) has a bolt-like connector (48).

2. The rectifier unit as recited in claim 1,
wherein
the flat webbed cable (33) has a U-shaped bolt receptacle (50) on which the bolt-type connector (48) is accommodated.

3. The rectifier unit as recited in claim 2,
wherein
the bolt-type connector (48) has a receiving neck (50) which is inserted in the U-shaped bolt receptacle (50).

4. The rectifier unit as recited in claim 1, wherein
the bolt-type connector (48) has a bolt section (55) located after the receiving neck (53), and on which the U-shaped bolt receptacle (50) is mounted.

5. The rectifier unit as recited in claim 4,
wherein
the bolt section (55) located after the receiving neck (53) has a form-fit contour (58) on its outer circumference, and the at least one conductor element of the wiring plate (30) is enclosed by insulating material (70) which encloses the form-fit contour (58).

6. The rectifier unit as recited in claim 3,
wherein
a collar (60) is located at least directly after the receiving neck (53), the outer diameter of which is greater than that of the receiving neck (53) and/or that of the bolt section (55) located after the receiving neck (53).

7. The rectifier unit as recited in claim 1,
wherein
a screw thread (62) is part of the bolt-type connector (48) in the direction toward an end opposite to the U-shaped bolt receptacle (50).

8. The rectifier unit as recited in claim 1,
wherein
the flat webbed cable (33) is bonded with the bolt-type connector (48), via welding or soldering in particular.

9. An electric machine, particularly an alternator, with a rectifier unit (10) as recited in claim 1,
wherein
a protective cap (90) covers the rectifier unit (10), and the bolt-type connector (48) extends through an opening (92) in the protective cap (90).
